(19) United States
(12) Patent Application Publication
(10) Pub. No.: US 2020/0324631 A1
(43) Pub. Date: Oct. 15, 2020

(54) ROLLING VEHICLE DOOR

(71) Applicant: Bernard von NotHaus, Cape Coral, FL (US)

(72) Inventor: Bernard von NotHaus, Cape Coral, FL (US)

(21) Appl. No.: 16/847,603

(22) Filed: Apr. 13, 2020

Related U.S. Application Data
(60) Provisional application No. 62/833,465, filed on Apr. 12, 2019.

(51) Int. Cl. B60J 5/08; E05D 1/04; B60J 5/14

(52) U.S. Cl. CPC B60J 5/08; E05Y 2900/531; B60J 5/14; E05D 1/04

(57) ABSTRACT

The system includes a vehicle and a rolling vehicle door. The rolling vehicle door includes a primary panel and a receptacle. The rolling vehicle door is positioned to provide access to an interior of the vehicle. The receptacle is coupled to the primary panel to receive the primary panel in an opening of the rolling vehicle door and release the primary panel in a closing of the rolling vehicle door.

### CROSS-REFERENCES TO RELATED APPLICATIONS

This application claims the benefit of, and claims priority to, U.S. Provisional Patent Application No. 62/833,465 entitled “ROLLING VEHICLE DOOR” and filed on 12 Apr. 2019 for Bernard von NotHaus, which is incorporated herein by reference for all purposes.

### FIELD

This invention relates to vehicle doors and, more particularly, relates to rolling vehicle doors.

### BACKGROUND

Vehicle doors are a critical part of the use and operation of the vehicle. Many considerations play a part in selection of materials, number, and design. These considerations include safety, ease of operation, ingress, and egress, cost, weight, various insulating properties, and the like.

### SUMMARY

A system is disclosed. The system includes a vehicle and a rolling vehicle door. The rolling vehicle door includes a primary panel and a receptacle. The rolling vehicle door is positioned to provide access to an interior of the vehicle. The receptacle is coupled to the primary panel to receive the primary panel in an opening of the rolling vehicle door and release the primary panel in a closing of the rolling vehicle door.

A rolling vehicle door is disclosed. The rolling vehicle door includes a primary panel and a receptacle. The primary panel includes a plurality of slats. Each of the plurality of slats is pivotably coupled to at least one adjoining slat of the plurality of slats. The receptacle is coupled to the primary panel to receive the primary panel in an opening of the rolling vehicle door and release the primary panel in a closing of the rolling vehicle door.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a side view illustrating one embodiment of a rolling vehicle door with a receptacle in a lower portion of a vehicle in accordance with the present invention;

FIG. 2 is a side view illustrating one embodiment of the rolling vehicle door with the receptacle in an upper portion of the vehicle in accordance with the present invention;

FIG. 3 is a side view illustrating one embodiment of the rolling vehicle door with the receptacle in a rearward portion of the vehicle in accordance with the present invention;

FIG. 4 is a side view illustrating one embodiment of the rolling vehicle door with the receptacles in a forward portion of the vehicle in accordance with the present invention;

FIG. 5 is a front view illustrating one embodiment of the rolling vehicle door with receptacles in the lower portion of the vehicle in accordance with the present invention;

FIG. 6 is a front view illustrating one embodiment of the rolling vehicle door with receptacles in the upper portion of the vehicle in accordance with the present invention;

FIG. 7 is a front view illustrating one embodiment of the rolling vehicle door with receptacles in a central upper portion of the vehicle in accordance with the present invention;

FIG. 8 is a side view illustrating one embodiment of the rolling vehicle door with the receptacle in a back portion of the vehicle in accordance with the present invention;

FIG. 9a is a side view illustrating one embodiment of the rolling vehicle door with the receptacle in an upper forward portion of the vehicle in accordance with the present invention;

FIG. 9b is a side view illustrate the embodiment of FIG. 9a with the rolling vehicle door retracted into the receptacle in accordance with the present invention;

FIG. 10 is a side view illustrating one embodiment of the rolling vehicle door positioned on a side and a top of the vehicle;

FIG. 11 is a view of the rolling vehicle door with a secondary panel; and

FIG. 12 is a view of another embodiment of the rolling vehicle door with a secondary panel separate from the primary panel.

### DETAILED DESCRIPTION OF THE INVENTION

Many of the functional units described in this specification have been labeled as modules, in order to more particularly emphasize their broad implementation independence. For example, a module may be implemented as a hardware component, an operation, or the like.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Any schematic flow chart diagrams included herein are generally set forth as logical flow chart diagrams. As such, any depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

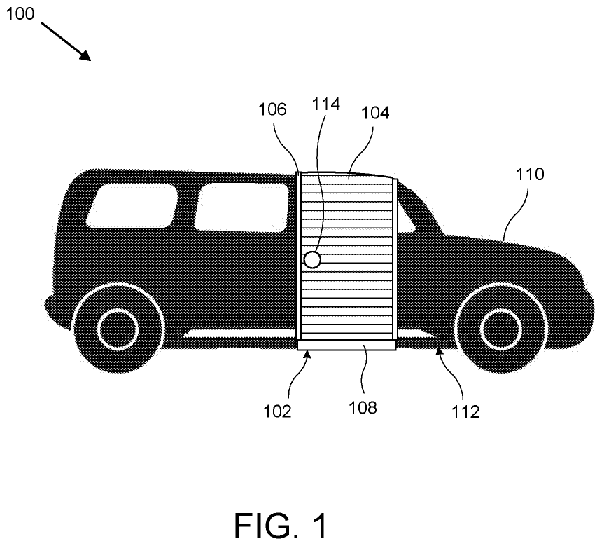

FIG. 1 is a side view illustrating one embodiment of a rolling vehicle door 100 with a receptacle 102 in a lower portion 112 of a vehicle 110 in accordance with the present invention. In the illustrated embodiment, the rolling vehicle door 100 is disposed on a side of the vehicle 110. As described in further detail herein, the rolling vehicle door 100 may be disposed on other locations or orientations on the vehicle 110.

In the illustrated embodiment, the rolling vehicle door 100 includes a primary panel 104. In some embodiments, the primary panel 104 includes a plurality of slats running across a width of the rolling vehicle door 100. The illustrated slats of primary panel 104 may be rectangular or may have a non-rectangular geometry. The slats may be coupled to one another by hardware or in a no-hardware configuration. For example, the slats may include a pinned connection. In another example, the slats may each have a tongue-and-groove connection holding one slat to another. In another example, the slats may include a flexible member between one or more of the slats to couple the slats to one another. The feature or component between the slats may provide additional benefits such as insulation, weather resistance, dust resistance, reduced noise of operation of the rolling vehicle door 102, or the like.

In some embodiments, the primary panel 104 may be formed, at least partially, with a fabric, mesh, cloth, sheet, or other material. For example, the rolling vehicle door 102 may include a non-slatted portion and a slatted portion. In other embodiments, the rolling vehicle door 102 omits the slats for another material or structure.

The illustrated embodiment also includes a channel 106 disposed along one or more edges of the primary panel 104. In some embodiments, the channels 106 are formed in the vehicle 110 itself. In other embodiments, the channels 106 are a component of the rolling vehicle door 102. The channels 106 may be coupled to the vehicle 110. In some embodiments, the channels 106 or other component of the rolling vehicle door 102 are removable relative to the vehicle 110 or other component of the rolling vehicle door 102. In other embodiments, the channels 106 or other component of the rolling vehicle door 102 are non-removably fixed relative to the vehicle 110 or other component of the rolling vehicle door 102. The rolling vehicle door 102 may be configured as a factory install or an aftermarket install.

In the illustrated embodiment, the rolling vehicle door 102 includes a receptacle 108. The receptacle 108 may be configured to receive the primary panel 104 of the rolling vehicle door 102. For example, the receptacle 108 may be shaped to allow the primary panel 104 to be rolled within the receptacle 108. The receptacle 108 may include one or more motivators such as springs, motors (electric or otherwise), hydraulics, magnets, reels, cranks, knobs, or the like, to facilitate retraction or deployment of the primary panel 104 of the rolling vehicle door 102 relative to the vehicle 110. Control of the rolling vehicle door 102 may be done from an exterior or interior of the vehicle 110. Additionally, the rolling vehicle door 102 may be controlled from a remote location such as a key fob, a garage-mounted control, or the like.

In the illustrated embodiment, the receptacle 108 is positioned on a lower portion 112 of the vehicle 110. For example, the receptacle 108 may be coupled underneath the vehicle 110. In other examples, the receptacle 108 may be mounted to, or at least partially recessed within, an outer surface of the side of the vehicle 110.

In some embodiments, the rolling vehicle door 102 is coupled to a portion of the receptacle 108. The rolling vehicle door 102 may be removable from the receptacle 108 or, in other embodiments, the rolling vehicle door 102 may be permanently coupled to the receptacle 108.

In some embodiments, the receptacle 108 is removeable or may be permanently attached to the vehicle 110. In some embodiments, different variants of the rolling vehicle door 102 may be connected to the vehicle 110. For example, a winter variant of the rolling vehicle door 102 may be coupled to the receptacle 108 or the vehicle 110. A winter variant of the rolling vehicle door 102 may include additional thermal insulation. Other variants such as a summer variant, an acoustically-insulated variant, a transparent variant, an open variant, a closed variant, an openable variant, a sealed variant, a lockable variant, a security variant, a lightweight variant, and the like.

In some embodiments, the rolling vehicle door 102 includes an interface structure 114. In some embodiments, the interface structure 114 facilitates opening or closing the rolling vehicle door 102, locking or unlocking the rolling vehicle door 102, coupling or uncoupling the rolling vehicle door 102, engaging or disengaging a feature of the rolling vehicle door 102, or the like.

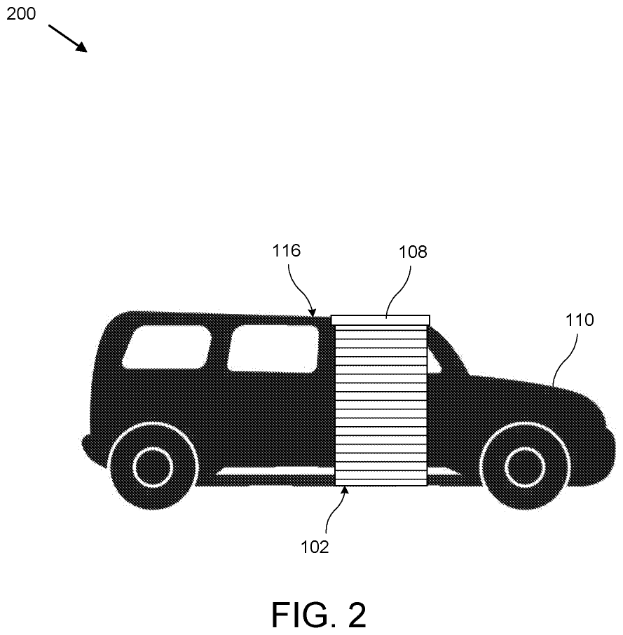

FIG. 2 is a side view 200 illustrating one embodiment of the rolling vehicle door 102 with the receptacle 108 in an upper portion 116 of the vehicle 110 in accordance with the present invention. In the illustrated embodiment, the receptacle 108 is positioned near the upper portion 116 or roof of the vehicle 110. Positioning the receptacle 108 near the upper portion 116 of the vehicle 110 may facilitate a lower clearance or reduce a clearance complication with the receptacle 108 positioned at a lower portion 112 of the vehicle 110.

In some embodiments, the vertical opening arrangement of the rolling vehicle door 102 may be intuitive opening from the bottom up. In some embodiments, the lifting motion to open the rolling vehicle door 102 may increase the ease of operation, improve the ergonomics, or take advantage of the psychological aspect of opening the rolling vehicle door 102.

In some embodiments, the positioning of the receptacle 108 near the upper portion 116 of the vehicle 110 may improve a structural aspect of the vehicle 110. For example, the receptacle 108 may be incorporated into a structural scheme, such as a frame of the vehicle 110, to improve crush resistance, prevent roll-over damage, or the like.

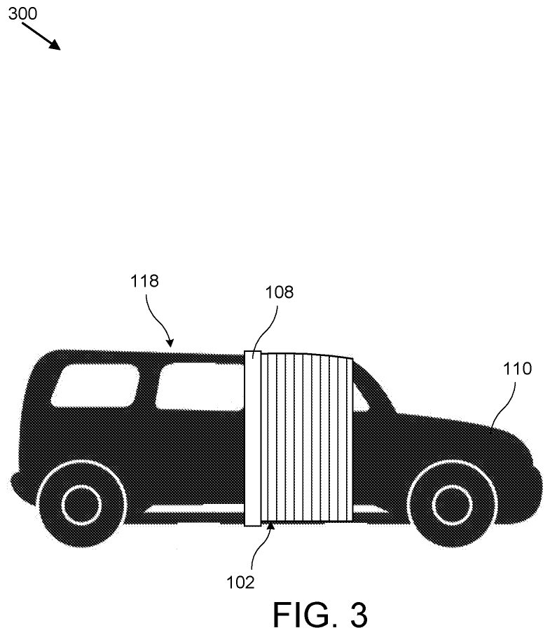

FIG. 3 is a side view 300 illustrating one embodiment of the rolling vehicle door 102 with the receptacle 108 in a rearward portion 118 of the vehicle 110 in accordance with the present invention. In some embodiments, the rolling vehicle door 102 may have a single receptacle 108 or multiple receptacles 108. For example, the rolling vehicle door 102 may have a plurality of portions which correspond with receptacles 108 placed apart from each other with the portions extending from the receptacles 108 to meet or otherwise jointly form the rolling vehicle door 102.

In some embodiments, the rolling vehicle door 102 may include a surface structure or geometry to provide reduced aerodynamic drag, improved water or dust ingress resistance, an aesthetic feature, or the like. The rolling vehicle door 102 may include straight or curved edges extending from the receptacle 108. The edges of the rolling vehicle door 102 may be identical or different from one another. In some embodiments, the rolling vehicle door 102 is parallel to the vehicle 110. For example, the rolling vehicle door 102 may be configured to move horizontally or vertically along the vehicle 110. In other embodiments, the rolling vehicle door 102 may be configured to move at an angle relative to the vehicle 110.

In some embodiments, the receptacle 108 corresponds with a structure of the vehicle 110. For example, the receptacle 108 may correspond with a door pillar, A pillar, B pillar, or other component or structure of the vehicle 110. In some embodiments, the receptacle 108 corresponding to the structure or other component of the vehicle 110 reduces additional blind-spot formation, restriction of passage in and out of the vehicle 110, and the like.

In some embodiments, the rolling vehicle door 102 has one or more latches or securing elements. The securing elements may be located on the rolling vehicle door 102 to be opposite the receptacle 108. In some embodiments, one or more of the securing elements is positioned along one or more edges of the rolling vehicle door 102 or at other locations on the rolling vehicle door 102 to provide locking or otherwise securing the rolling vehicle door 102 relative to at least one of the receptacle 108 and the vehicle 110.

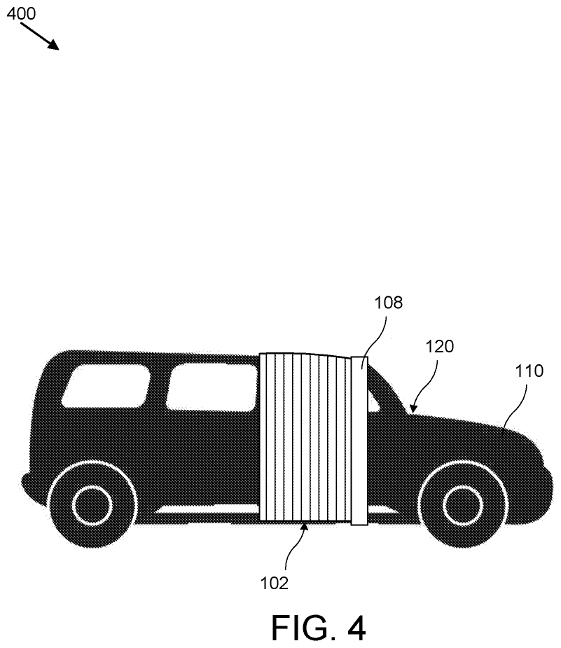

FIG. 4 is a side view 400 illustrating one embodiment of the rolling vehicle door 102 with the receptacle 108 in a forward portion 120 of the vehicle 110 in accordance with the present invention. In the illustrated embodiment, the rolling vehicle door 102 opens towards the forward portion of the vehicle 110. In some embodiments, the receptacle 108 is aligned with an a-pillar of the vehicle 110 to reduce additional blind-spot creation. The receptacle 108 may be aligned or positioned to correspond with or be separate from other components of the vehicle 110.

Having the rolling vehicle door 102 open towards a forward portion 120 of the vehicle 110 may be more familiar to a driver or passenger of the vehicle 110. Additionally, the rolling vehicle door 102 may be configured to extend a full height of the vehicle 110 or less than a full height of the vehicle 110. In some embodiments, the rolling vehicle door 102 may be secured in a partially closed position in which the rolling vehicle door 102 is not fully closed. For example, the rolling vehicle door 102 may include intermediate securing points and corresponding hardware to secure the rolling vehicle door 102 at on or more partially closed positions in addition to the fully closed position shown in FIG. 4.

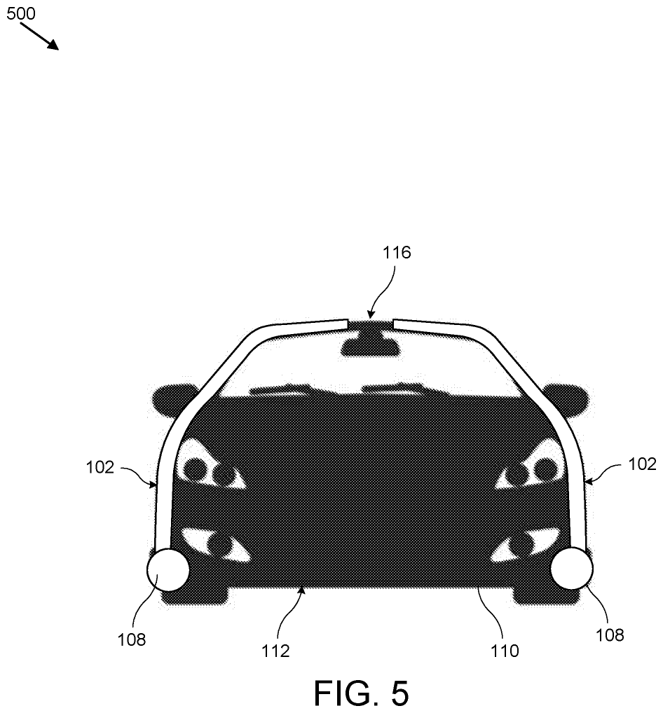

FIG. 5 is a front view 500 illustrating one embodiment of the rolling vehicle door 102 with receptacles 108 in the lower portion 112 of the vehicle 110 in accordance with the present invention. In the illustrated embodiment, the rolling vehicle doors 102 are positioned on either side of the vehicle 110 to facilitate ingress and egress at either side of the vehicle 110.

In the illustrated embodiment, the receptacles 108 are positioned at or near a lower portion 112 of the vehicle 110. In other embodiments, the receptacles 108 are positioned at some distance from the lower portion 112 of the vehicle 110. The receptacles 108 may be recessed within the vehicle 110 or position underneath the vehicle 110. Other positions are also contemplated.

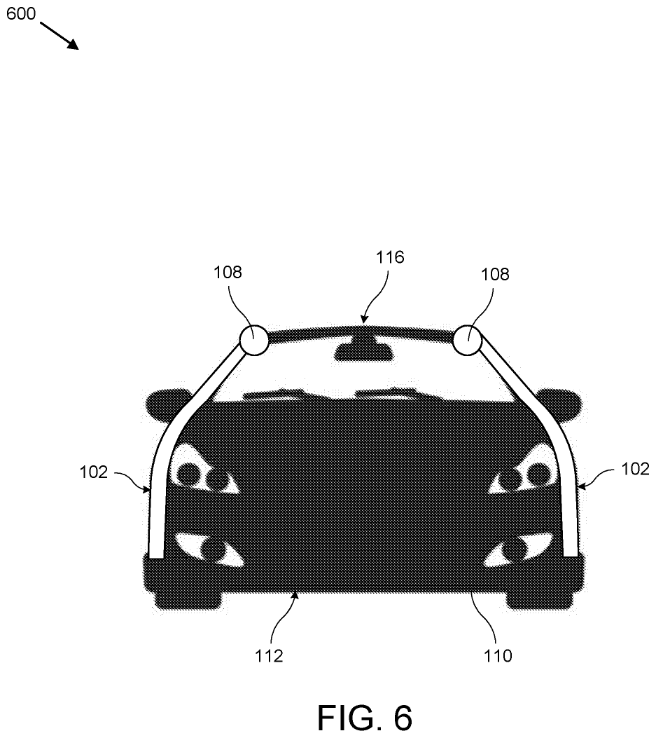

FIG. 6 is a front view 600 illustrating one embodiment of the rolling vehicle door 102 with receptacles 108 in the upper portion 116 of the vehicle 110 in accordance with the present invention. In some embodiments, the positioning of the receptacles 108 in the upper portion 116 of the vehicle 110. The receptacles 108 may be placed at a top of a doorway which may be at an edge of a roof, towards a center of the roof, or at an intermediate location on the upper portion 116 of the vehicle 110.

In some embodiments described and shown herein, the receptacles 108 are cylindrical or shaped containers which allow a corresponding portion of the rolling vehicle door 102 to roll or otherwise collapse into the receptacles 108. In other embodiments, the receptacles 108 may be formed to receive the corresponding portion of the rolling vehicle door 102 without rolling, collapsing, or the like. For example, the receptacle 108 may be an area formed in the body of the vehicle 110 which allows the rolling vehicle door 102 to hide within the body of the vehicle 110 when open or partially open. This may allow for reduced wear and tear, a lower flexibility requirement for the rolling vehicle door 102, a smaller form profile for the receptacle 108, and the like. As an example, in the illustrated embodiment of FIG. 6, the receptacles 108 may be formed to overlap one another on or within the roof of the vehicle 110 to effectively stack the rolling vehicle doors 102 on the upper portion 116 of the vehicle 110 when both are in the open position.

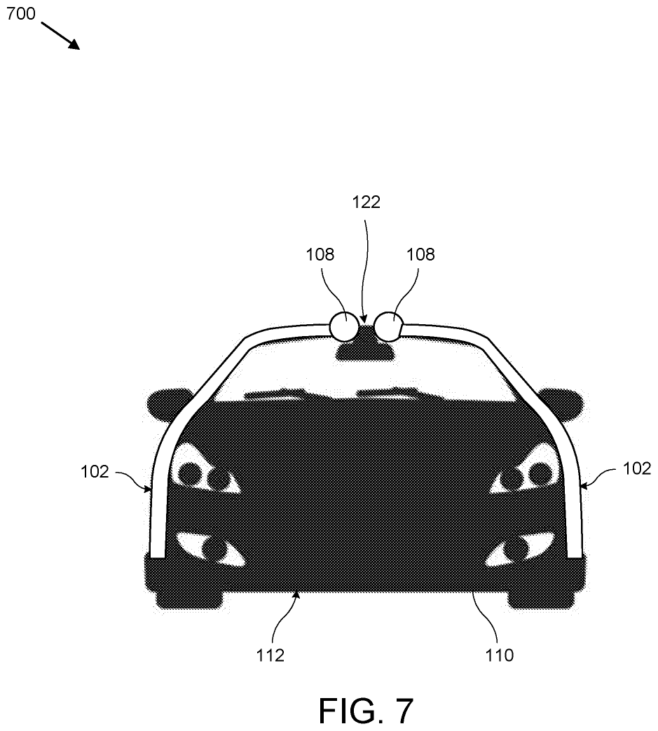

FIG. 7 is a front view 700 illustrating one embodiment of the rolling vehicle door 102 with receptacles 108 in a central upper portion 122 of the vehicle 110 in accordance with the present invention. In the illustrated embodiment, the receptacles 108 are positioned in a T-top or convertible-like arrangement. This arrangement may provide opportunity to incorporate a sunroof, moonroof, T-top, or similar structure into the rolling vehicle door 102. Additionally, the illustrated embodiment may provide greater headroom and improve ease of ingress to and egress from the vehicle 110.

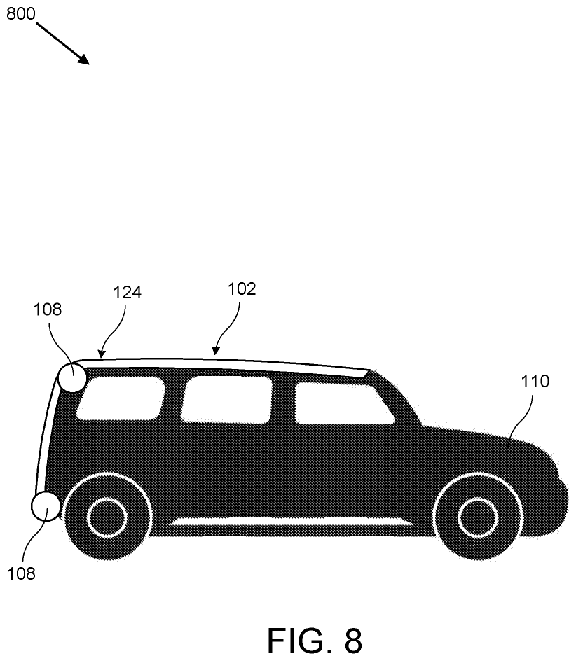

FIG. 8 is a side view illustrating one embodiment of the rolling vehicle door 102 with the receptacle 108 in a back portion 124 of the vehicle 110 in accordance with the present invention. In the illustrated embodiment, the receptacle 108 is positioned to allow the rolling vehicle door 102 to cover the top of the vehicle 110 from the windshield to the back portion 124. In some embodiments, the illustrated arrangement provides a convertible-like functionality. While the receptacle 108 is shown herein as being positioned at particular location at the back portion 124 of the vehicle 110, the receptacle 108 may be further rearward, forward, lower, or higher on the vehicle 110.

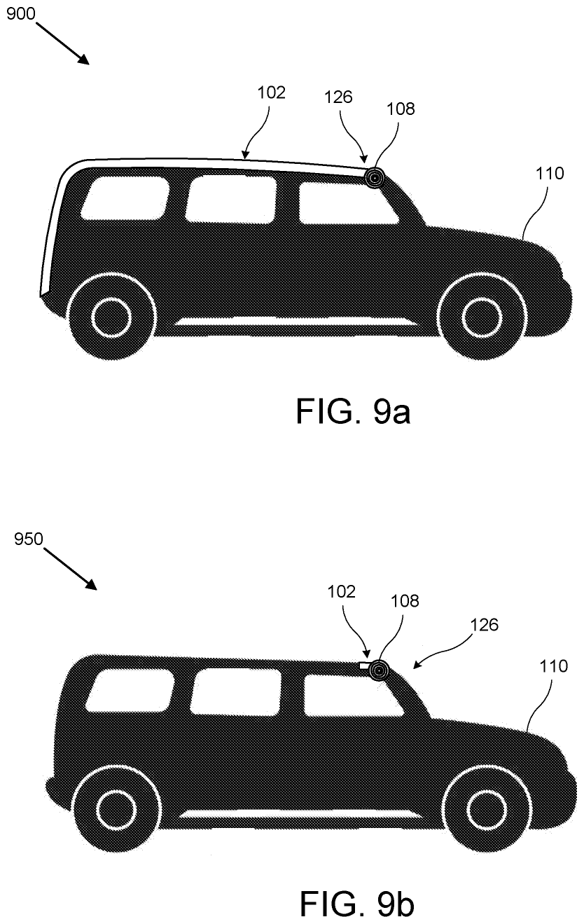

FIG. 9a is a side view 900 illustrating one embodiment of the rolling vehicle door 102 with the receptacle 108 in an upper forward portion 126 of the vehicle 110 in accordance with the present invention. In the illustrated embodiment, the rolling vehicle door 102 may provide the same convertible-like functionality as described above with respect to FIG. 8. In this embodiment, the rolling vehicle door 102 may be partially opened to provide cover over a portion of the vehicle 110 while opening a rear portion of the vehicle 110.

FIG. 9b is a side view 950 illustrate the embodiment of FIG. 9a with the rolling vehicle door 102 retracted into the receptacle 108 in accordance with the present invention. As described above, the rolling vehicle door 102 may be retracted in a rolling fashion, as shown. In other embodiments, the rolling vehicle door 102 may be stowed outside or within the vehicle 110 or a body panel of the vehicle 110 without needing to retract the rolling vehicle door 102 in a concentric rolling configuration within the receptacle 108.

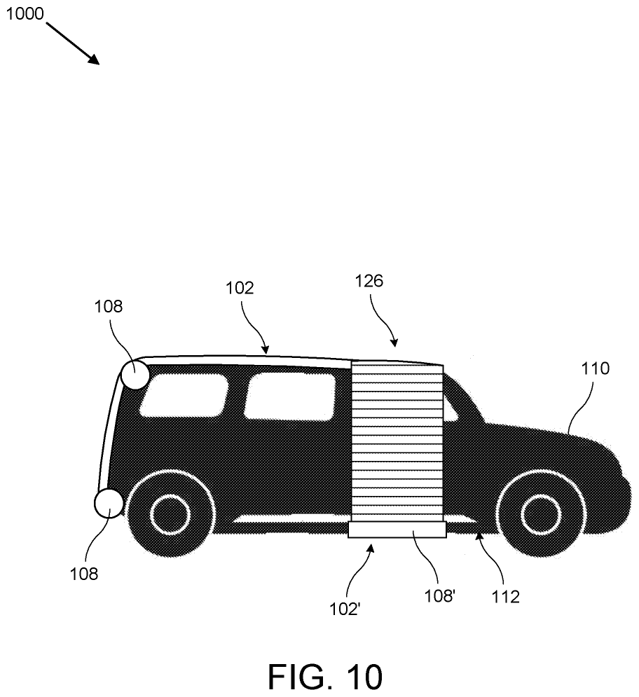

FIG. 10 is a side view 1000 illustrating one embodiment of a first rolling vehicle door 102 positioned on a top of the vehicle 110 and a second rolling vehicle door 102¹ positioned on a side of the vehicle 110. In some embodiments, multiple rolling vehicle doors 102 and 102¹ may be positioned on the vehicle 110 to provide opening and closing functionality. In some embodiments, the rolling vehicle doors 102 and 102¹ may interface with one another. For example, the rolling vehicle doors 102 and 102¹ may connect to one another, may have a closure order, may create a locking interaction with one another, or the like. In other embodiments, the rolling vehicle doors 102 and 102¹ may be independent of one another.

In some embodiments, the rolling vehicle doors 102 and 102¹correspond to separate receptacles 108. In other embodiments, the rolling vehicle doors 102 and 102¹ correspond to a unified receptacle 108. For example, a single receptacle 108 may be formed and/or positioned to receive both of the rolling vehicle doors 102 and 102¹at a single location on the vehicle 110.

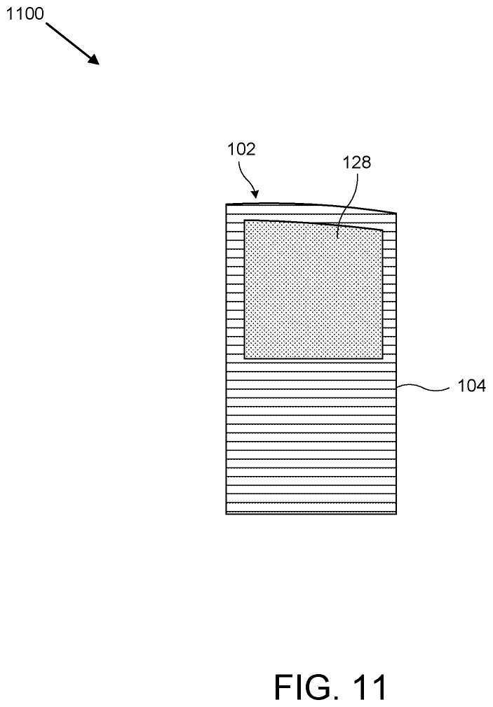

FIG. 11 is a view 1100 of the rolling vehicle door 102 with a secondary panel 128. In some embodiments, the secondary panel 128 is disposed in the slats forming the primary panel 104 of the rolling vehicle door 102. As described above, the primary panel 104 may include other structures or materials. For example, the rolling vehicle door 102 may be constructed of a single piece of flexible material, multiple pieces of rigid material, multiple pieces of flexible material, or the like.

In the illustrated embodiment, the rolling vehicle door 102 includes a secondary panel 128. The secondary panel 128 may include a transparent structure, an armored structure, a reflective or privacy structure, an air permeable structure, a safety structure, or the like. The secondary panel 128 may be a single-piece structure or may include multiple pieces or components.

In some embodiments, the secondary panel 128 is removably coupled to the rolling vehicle door 102. In other embodiments, the secondary panel 128 is permanently coupled to the rolling vehicle door 102. In some embodiments, the secondary panel 128 is repositionable relative to the rolling vehicle door 102. For example, the secondary panel 128 may be rolled down or otherwise repositioned to form at least a partial opening in the rolling vehicle door 102. Additional structure, such as a handle, latch, button, motor, trigger, or the like, may be included to facilitate positioning of the secondary panel 128 or other operation of the rolling vehicle door 102.

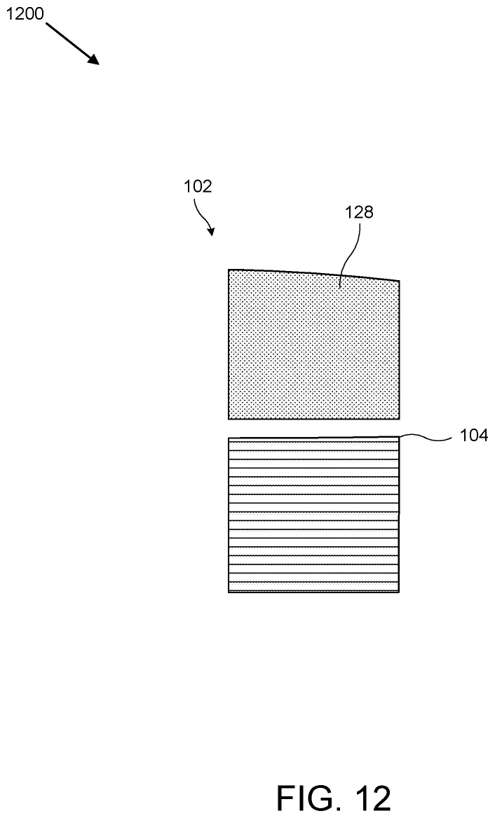

FIG. 12 is a view 1200 of another embodiment of the rolling vehicle door 102 with a secondary panel 128 separate from the primary panel 104. In the illustrated embodiment, the secondary panel 128 opens separately from the primary panel 104. In some examples, the manner of retraction for the secondary panel 128 is different from that of the primary panel 104. In other examples, the primary panel 104 of the secondary panel 128 may operate in similar manners. For example, one or more of the primary panel 104 and the secondary panel 128 may retract in a rolling, sliding, hinging, pivoting, disconnecting, or other manner. Embodiments described herein include panels or parts of the rolling vehicle door 102 which may couple to one another to form the rolling vehicle door 102. For example, the primary panel 104 and the secondary panel 128 may meet together in a closing operation and couple to one another. In another example, two rolling doors 102 may meet together to close the roof, door, back, side, or other portion of the vehicle 110.

In some embodiments, the rolling vehicle door 102 may include a hinge or other secondary structure in addition to the receptacle 108 described above. In some embodiments, the secondary structure may be incorporated into the channel 106 of FIG. 1 or some other component of the rolling vehicle door 102 or the vehicle 110. In some embodiments, the secondary structure provides an alternative operating option. The secondary structure may facilitate emergency operation of the rolling vehicle door 102 or operation to accommodate operation of the rolling vehicle door 102 with a physical or other medical condition which may impact an ability to operate the rolling vehicle door 102.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a vehicle;
a rolling vehicle door positioned to provide access to an interior of the vehicle, the rolling vehicle door comprising:
a primary panel; and
a receptacle coupled to the primary panel to receive the primary panel in an opening of the rolling vehicle door and release the primary panel in a closing of the rolling vehicle door.

2. The system of claim 1, wherein the rolling vehicle door further comprises at least one channel disposed along one or more edges of the primary panel.

3. The system of claim 1, wherein the rolling vehicle door further comprises an interface structure to facilitate an operation at the rolling vehicle door.

4. The system of claim 1, wherein the rolling vehicle door further comprises a secondary panel disposed in the primary panel.

5. The system of claim 4, wherein the secondary panel is at least partially transparent.

6. The system of claim 4, wherein the secondary panel is at least partially air permeable.

7. A rolling vehicle door comprising:
a primary panel comprising a plurality of slats, wherein each of the plurality of slats is pivotably coupled to at least one adjoining slat of the plurality of slats; and
a receptacle coupled to the primary panel to receive the primary panel in an opening of the rolling vehicle door and release the primary panel in a closing of the rolling vehicle door.

8. The rolling vehicle door of claim 7, wherein the plurality of slats are configured to allow the primary panel to roll onto itself within the receptacle.

9. The rolling vehicle door of claim 8, wherein the plurality of slats are positioned to extend horizontally along the primary panel to allow the rolling vehicle door to open and close vertically.

10. The rolling vehicle door of claim 7, further comprising an interface structure to facilitate at least one of opening and closing the rolling vehicle door.

11. The rolling vehicle door of claim 7, further comprising at least one channel disposed along one or more edges of the primary panel.

12. The rolling vehicle door of claim 7, further comprising a secondary panel at least partially disposed in the primary panel.

13. The rolling vehicle door of claim 12, wherein a characteristic of the secondary panel is different from a characteristic of the primary panel.

14. The rolling vehicle door of claim 7, wherein the primary panel comprises acoustic insulation.

15. The rolling vehicle door of claim 7, wherein the primary panel comprises thermal insulation.

16. The rolling vehicle door of claim 7, wherein the primary panel comprises a weather seal.

17. The rolling vehicle door of claim 7, further comprising a motor to move the primary panel relative to the receptacle.

18. The rolling vehicle door of claim 7, further comprising a spring to move the primary panel relative to the receptacle.

19. The rolling vehicle door of claim 7, further comprising a remote control to operate the rolling vehicle door remotely.

20. The rolling vehicle door of claim 7, further comprising a securing element to secure the rolling vehicle door in at least one of an open and closed position.
